(19) United States
(12) Patent Application Publication
(10) Pub. No.: US 2010/0115317 A1
(43) Pub. Date: May 6, 2010

(54) GENERATION OF AN IDLE MODE SIGNAL FOR AN ELECTRICAL CONTROL DEVICE

(75) Inventors: Dirk Aurich, Berlin (DE); Konrad Götz, Kelheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/515,417

(22) PCT Filed: Nov. 6, 2007
(86) PCT No.: PCT/EP2007/061914

§ 371 Date: Dec. 14, 2009

(30) Foreign Application Priority Data
Nov. 20, 2006 (DE) 10 2006 054 539.7

(51) Int. Cl. G06F 1/32; G06F 1/26

(52) U.S. Cl. 713/323; 713/320; 713/300

(57) ABSTRACT

A method for generating a low-voltage power supply for an electrical control device, the method includes switching a first power supply unit to one of an active mode and an idle mode by inputting an activation/deactivation input to the first power supply unit, wherein the activation/deactivation input is input by one of connecting a low-voltage switching signal to the first power supply unit and disconnecting the low-voltage switching signal from the first power supply unit, wherein the low-voltage switching signal is generated at an output end by an additional power supply unit, at least in the idle mode of the first power supply unit, and wherein the low-voltage signal is one of connected and disconnected from the activation/deactivation input of the power supply unit using a low-voltage switch. The invention further relates to a low-voltage power supply circuit of an electrical control device for carrying out such a method.

The invention relates to a method for generating a low-voltage power supply for an electrical control device and further relates to a low-voltage power supply circuit of an electrical control device for carrying out such a method.

Such methods and power supply circuits are used in domestic appliance engineering, for example, in particular for generating the low-voltage power supply for an electrical control device in washing machines, dishwashers etc.

At the present time the electrical control device is usually embodied as an electronic control element such as a microprocessor.

To conserve energy, modern washing machines often have an idle mode, also known as a standby mode, in order to switch off the power sink and detect when the machine is switched on again. The microprocessor or electrical control device therefore has to remain connected to the power supply even in standby mode.

Disadvantageously the energy consumption in standby mode is relatively high even in a washing machine of this type, and particularly in view of present day energy conservation requirements.

The object of the present invention is to create a method for generating a low-voltage power supply for an electrical control device and further to create a low-voltage power supply circuit of an electrical control device for carrying out such a method, in order to further reduce energy consumption while still satisfying the high expectations for functionality and operating convenience.

This object is inventively achieved by means of a method for generating a low-voltage power supply for an electrical control device with features which will emerge from claim 1, and by means of a low-voltage power supply circuit of an electrical control device with features which will emerge from claim 3.

By using a first power supply unit, in particular a switching power supply unit with an activation/deactivation input, also known as an enable/disable input, the first power supply unit can be deactivated, for example by switching off the timing, so that the idle current requirement for this type of standby mode is very low or virtually nil. For this purpose the low-voltage output of a further (standby) power supply unit, which carries a low-voltage switching signal, is inventively connected to or disconnected from the activation/deactivation input by means of a low-voltage switch. This ensures that when necessary the first power supply unit changes to an idle mode with lower energy consumption, from which it can be activated to a normal (active) operating mode by an operator without any adverse effect on operating convenience or functionality.

In a preferred embodiment of the invention the further power supply unit is designed as a capacitor-based power supply unit, and the energy drain in standby mode can then be further reduced by the lower power consumption of this device.

In a further embodiment of the invention the low-voltage switch, which is preferably operated manually, can be designed as a position, in particular a rotary switch position, of a program selector, or can be integrated into such a selector. A program selector of this type is also capable of controlling further functions in a large number of appliances. For example it is conceivable for the low-voltage switch to be embodied as a contact bridge at a particular selection position of a carbon touch selector.

Further advantageous embodiments of the invention will emerge from the subclaims.

The invention will be explained below in greater detail with the aid of an exemplary embodiment shown in the drawing.

The drawing shows:

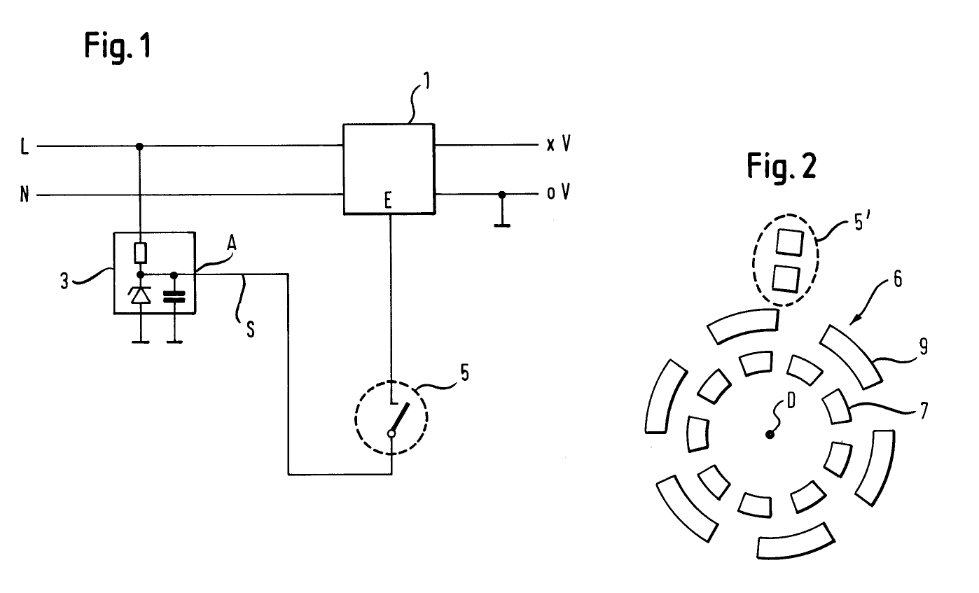

FIG. 1A schematic circuit diagram of a low-voltage power supply circuit of an electrical control device according to the invention and

FIG. 2A schematic diagram of a rotary program selector with a low-voltage switch in the form of a contact bridge.

As can be seen in FIG. 1, the inventive low-voltage power supply circuit has a power supply unit, in particular a switching power supply unit 1, which is connected on the primary side to a conventional AC supply with phase L and neutral conductor N. On the output side said switching power supply unit 1 is used to supply the electrical control device, for example a microprocessor or microcontroller (not shown in greater detail), of an electrical power sink, for example a domestic appliance such as a washing machine, a dishwasher, a washer-dryer, etc. In order to enable an energy saving idle mode or standby mode in an inactive control device, that is, a control device which is outside of its normal working mode or operating mode, the switching power supply unit 1 has in the inventive circuit an activation/deactivation input E (also known as an enable/disable input) which is connected via a low-voltage switch 5 to a further power supply unit, in particular a capacitor-based power supply unit 3. On its output A, said capacitor-based power supply unit generates a low-voltage switching signal S which is present on the input E of the switching power supply unit 1 when the switch 5 is in the closed position. The switching power supply unit 1 can be switched to an active mode, that is normal operating mode, by the presence of the switching signal S on the input E or it can be switched to an inactive mode by disconnecting the switching signal from the input E. Thus the switching power supply unit 1 is activated or deactivated by for example activating or deactivating the usual timing for such a switching power supply unit 1, so that deactivating the timing or other feature of the switching power supply unit 1 makes possible a very low idle current requirement of virtually nil. When the switching power supply unit 1 needs to be activated, it is sufficient to close the switch 5 so that the switching signal S, generated by the further energy-free power supply unit 3, is present on the input E of the switching power supply unit 1.

Since the switching signal S does not require high power, a low-energy power supply unit 3 can be used, in particular a capacitor-based power supply unit, which has very low energy consumption and therefore increases the total energy needs of the circuit in the active mode of the switching power supply unit 1 by only an imperceptible or insignificant amount. On the other hand the saving in standby mode or idle mode, compared with conventional circuits such as washing machine control circuits, is considerable, since the idle current requirement is henceforth virtually nil. At the same time conventional standby circuits have a considerably higher idle current requirement, since in the case of a washing machine controller in standby mode for example, the electronic control element such as a microprocessor for switching cut-off relays or power sinks on and off and/or for detecting when the machine is switched on again usually continues to be supplied with current.

It is of course also possible to activate the further power supply unit 3 just for the time during which a switching signal S is required to be available.

It is also conceivable for the input E to be inverted, that is, when a switching signal is present the switching power supply unit is deactivated and then activated when the switching signal S is disconnected from the input E.

As can be seen in FIG. 2, the low-voltage switch 5 according to FIG. 1 can be embodied as a contact bridge 5′ of a rotary program selector 6, the contact bridge 5′ being bridged in conducting mode or closed when brought into a certain position of the rotary program selection knob about its axis of rotation D perpendicular to the drawing plane. FIG. 2 also shows further contact bridges, between contact surfaces 7 on an inner track and contact surfaces 9 on an outer track, which can be closed or actuated depending on the rotational position set by an operator about the axis D of a rotary program selection knob.

It is also conceivable for the contact bridge 5′ to be provided at an existing position or at least one further contact bridge, or as a single additional position. It is further conceivable to use the switch 5 or the contact bridge 5′ to supply input E with the switching signal S for only a brief interval and to open the contact 5′ or the switch 5 again following activation. For this purpose the input E can be switched by means of a self-inhibiting circuit such as a flip-flop, it being possible to effect disconnection by closing the contact once more and/or connecting the switching signal to a further input of the switching power supply unit 1 or of an upstream input circuit.

The circuit described above and the method envisaged for achieving said circuit make it advantageously possible to produce low standby consumption without the need for a special microcontroller, as would otherwise be the norm. The inventive method, as shown in the example of the inventive circuit, is also cost-effective to produce, so that the advantage of the reduction in consumption costs outweighs the relatively slight increase in manufacturing costs.

### KEY TO REFERENCE NUMBERS

1 Switching power supply unit
3 Capacitor-based power supply unit
5 Low-voltage switch
5′ Contact bridge
6 Rotary program selector
7 Contact surfaces
9 Contact surfaces
L Phase
N Neutral conductor
V Low voltage (positive pole)
0 Ground (negative pole)
A Output
D Axis of rotation
E Input
S Low-voltage switching signal

1-6. (canceled)

7. A method for generating a low-voltage power supply for an electrical control device, the method comprising:
switching a first power supply unit to one of an active mode and an idle mode by inputting an activation/deactivation input to the first power supply unit,
wherein the activation/deactivation input is input by one of connecting a low-voltage switching signal to the first power supply unit and disconnecting the low-voltage switching signal from the first power supply unit,
wherein the low-voltage switching signal is generated at an output end by an additional power supply unit, at least in the idle mode of the first power supply unit, and
wherein the low-voltage signal is one of connected and disconnected from the activation/deactivation input of the power supply unit using a low-voltage switch.

8. The method as claimed in claim 7, wherein the electrical control device is a controller of a washing machine.

9. The method as claimed in claim 7, wherein the additional power supply unit that generates the low-voltage switching signal is a capacitor-based power supply unit.

10. The low-voltage power supply circuit for an electrical control device for carrying out the method as claimed in claim 7, the low-voltage power supply circuit comprising:
the first power supply unit which can be switched to the one of the active mode and the idle mode by the activation/deactivation input by the one of connecting a low-voltage switching signal to the first power supply unit and disconnecting the low-voltage switching signal from the first power supply unit;
the additional power supply unit that generates the low-voltage switching signal at the output end of the additional power supply unit, at least in the idle mode of the first power supply unit; and
the low-voltage switch that one of connects the low-voltage switching signal output from the additional power supply unit to the first power supply unit and disconnects the low-voltage switching signal output from the additional power supply unit from the first power supply unit.

11. The circuit as claimed in claim 10, wherein the electrical control device is a controller of a washing machine.

12. The circuit as claimed in claim 10, wherein the additional power supply unit is a capacitor-based power supply unit.

13. The circuit as claimed in claim 10, wherein the low-voltage switch is a position of a program selector.

14. The circuit as claimed in claim 13, wherein the low-voltage switch is a rotary switch position of the program selector.

15. The circuit as claimed in claim 13, wherein the program selector is a carbon-coated selector.

16. A method for generating a low-voltage power supply for an electrical control device, the method comprising:
generating a low-voltage switching signal at an output end of an additional power supply unit;
one of connecting, using a low-voltage switch, the low-voltage switching signal to an activation/deactivation input of a first power supply unit and disconnecting, using the low-voltage switch, the low-voltage switching signal from the activation/deactivation input of the first power supply unit to switch the first power supply unit to one of an active mode and an idle mode.

17. The method as claimed in claim 16, wherein the additional power supply unit generates the low-voltage switching signal at the output end at least in the idle mode of the first power supply unit.

18. The method as claimed in claim 16, wherein the electrical control device is a controller of a washing machine.

19. The method as claimed in claim 16, wherein the additional power supply unit that generates the low-voltage switching signal is a capacitor-based power supply unit.

20. A low-voltage power supply circuit for an electrical control device, the low-voltage power supply circuit comprising:
a first power supply unit having an activation/deactivation input, the first power supply unit configured to be switched to one of an active mode and an idle mode upon receipt of a low voltage switching signal at the activation/deactivation input;
an additional power supply unit having an output end, the additional power supply unit generating the low-voltage switching signal at the output end, at least in the idle mode of the first power supply unit; and
a low-voltage switch coupling the output end of the additional power supply unit to the activation/deactivation input of the first power supply unit,
wherein the low-voltage switch one of connects the low-voltage switching signal generated by the additional power supply unit to the first power supply unit and disconnects the low-voltage switching signal generated by the additional power supply unit from the first power supply unit to switch the first power supply unit to the one of the active mode and the idle mode.

21. The circuit as claimed in claim 20, wherein the electrical control device is a controller of a washing machine.

22. The circuit as claimed in claim 20, wherein the additional power supply unit is a capacitor-based power supply unit.

23. The circuit as claimed in claim 20, wherein the low-voltage switch is a position of a program selector.

24. The circuit as claimed in claim 23, wherein the low-voltage switch is a rotary switch position of the program selector.

25. The circuit as claimed in claim 23, wherein the program selector is a carbon-coated selector.
